(19) United States
(12) Patent Application Publication
(10) Pub. No.: US 2002/0067019 A1
(43) Pub. Date: Jun. 6, 2002

(54) Contracture relieving adjustable wheelchair

(75) Inventor: Mark Brown, San Antonio, TX (US)

Correspondence Address: WAYNE J COLTON INC, THE MILAM BUILDING SUITE 1032, 115 EAST TRAVIS STREET, SAN ANTONIO, TX, 78205, US

(73) Assignee: Mark Brown

(21) Appl. No.: 09/730,449

(22) Filed: Dec. 5, 2000

(51) Int. Cl. B62M 1/14

(52) U.S. Cl. 280/250.1; 280/304.1

(57) ABSTRACT

An adjustable wheelchair for relieving the effects of contracture generally comprises a base frame assembly and a seat frame assembly pivotally supported by the base frame assembly. The seat frame assembly has a torso section, a seat section and a leg section and is adjustable between a seated position and a supine position. Adjustment of the seat frame assembly between the seated position and the supine position is measurable by an acute angle α between the torso section and a vertical reference. The torso section is adapted to articulate with respect to the seat section, measurable by an acute angle β. The leg section is adapted to articulate with respect to the seat section, measurable by an acute angle θ between the leg section and the seat section. Articulation of the torso section and the leg section with respect to the seat section are constrained such that the angle β and the angle θ change concurrently with, and within predefined limits according to, the angle α as the seat frame assembly is adjusted between the seated position and the supine position.

### FIELD OF THE INVENTION

The present invention relates to adjustable wheelchairs. More particularly, the invention relates to an adjustable wheelchair, having an articulating patient supporting seat assembly, that is particularly adapted to reduce or wholly eliminate the painful effects of contracture concomitant prolonged immobility.

### BACKGROUND OF THE INVENTION

In order to minimize the effects of contracture, the generally accepted standard of care for wheelchair support of a patient has often included the requirement for maximum independent adjustment of the various portions of a wheelchair. As a result, the prior art generally teaches that in a wheelchair with an articulating seat frame assembly, the torso and leg sections should be freely adjustable, one independent of the other, with respect to the seat section. Additionally, it is generally accepted that adjustment of the articulating sections should be independently controllable from adjustment of the seat frame assembly between seated and supine positions. Through confidential experimental observation, Applicant has come to disagree with the teachings of the prior art and, as a result, has developed a unique wheelchair design directed toward the elimination of contracture-related pain through the carefully coordinated, constrained, substantially simultaneous movement of the various parts of the wheelchair.

### SUMMARY OF THE INVENTION

In accordance with the foregoing objects, the present invention—an adjustable wheelchair for relieving the effects of contracture—generally comprises a base frame assembly and a seat frame assembly pivotally supported by the base frame assembly. The seat frame assembly has a torso section, a seat section and a leg section and is adjustable between a seated position and a supine position. Adjustment of the seat frame assembly between the seated position and the supine position is measurable by an acute angle α between the torso section and a vertical reference. The torso section is adapted to articulate with respect to the seat section, measurable by an acute angle β. Likewise, the leg section is also adapted to articulate with respect to the seat section, measurable by an acute angle θ between the leg section and the seat section. Additionally, articulation of the torso section and the leg section with respect to the seat section are constrained such that the angle β and the angle θ change concurrently with, and within predefined limits according to, the angle α as the seat frame assembly is adjusted between the seated position and the supine position.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a right side perspective view, the preferred embodiment of the contracture relieving adjustable wheelchair of the present invention in its seated configuration;

FIG. 2 shows, in a right side perspective view, the contracture relieving adjustable wheelchair of FIG. 1 in its supine position;

FIG. 3 shows, in a rear perspective view, the contracture relieving adjustable wheelchair of FIG. 1;

FIG. 4 shows, in a front perspective view, the contracture relieving adjustable wheelchair of FIG. 1;

FIG. 5 shows, in a left side perspective view, details of the base frame assembly of the wheelchair of FIG. 1;

FIG. 6 shows, in a left side perspective view, details of the seat frame assembly of the wheelchair of FIG. 1;

FIG. 7 shows, in a schematic cross sectional view corresponding generally to line 7-7 of FIG. 3, details of the interface of the seat frame assembly of the wheelchair with the base frame assembly of the wheelchair when the wheelchair is in its seated configuration;

FIG. 8 shows, in a schematic cross sectional view similar to that of FIG. 7, details of the interface of the seat frame assembly with the base frame assembly when the wheelchair is in its supine configuration;

FIG. 9 shows, in a right side elevational view, details of the rear clevis assembly and the electric actuator assembly as interfaced for controlling movement of the seat frame assembly relative to the base frame assembly;

FIG. 10 shows, in a rear elevational view, the rear clevis assembly of FIG. 9;

FIG. 11 shows, in a partially cut away right side elevational view, details of the front clevis assembly and the electric actuator assembly as interfaced for controlling movement of the seat frame assembly relative to the base frame assembly;

FIG. 12 shows, in a schematic cross sectional view similar to that of FIG. 7, details of an alternative embodiment of the present invention employing mechanical control of the movement of the seat frame assembly relative to the base frame assembly; and

FIG. 13 shows, in a side elevational view, details of the interface of the wheelchair's head rest assembly to the wheelchair's seat back.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

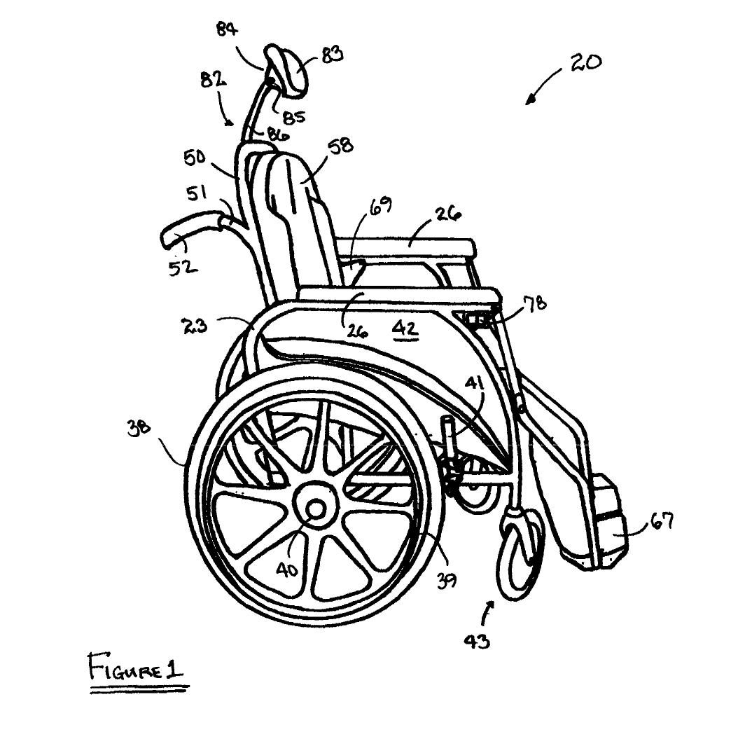

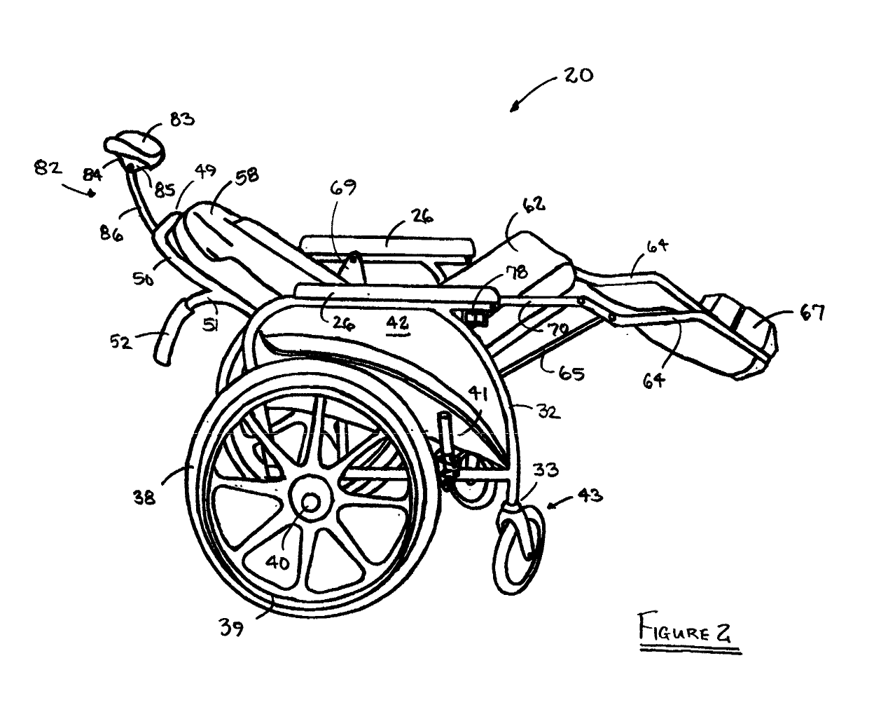

Referring now to the figures, the contracture relieving adjustable wheelchair 20 of the present invention is shown to generally comprise a base frame assembly 21 and an articulating seat frame assembly 44 having a torso section 45, a seat section 46 and a leg section 47. As will be better understood further herein, an articulation mechanism 71 is provided for the simultaneous articulation of the torso section 45 and leg section 47 with respect to the seat section 46 as the entire seat frame assembly 47 is adjusted, between a seated position, as generally shown in FIG. 1, and a supine position, as generally shown in FIG. 2, with respect to the base frame assembly 21. As also will be better understood further herein, this coordinated articulation of the seat frame assembly 44, according to those constraints detailed further herein, has been found by Applicant to be particularly effective in relieving the painful effects of contracture otherwise concomitant periodic movement of an immobilized patient.

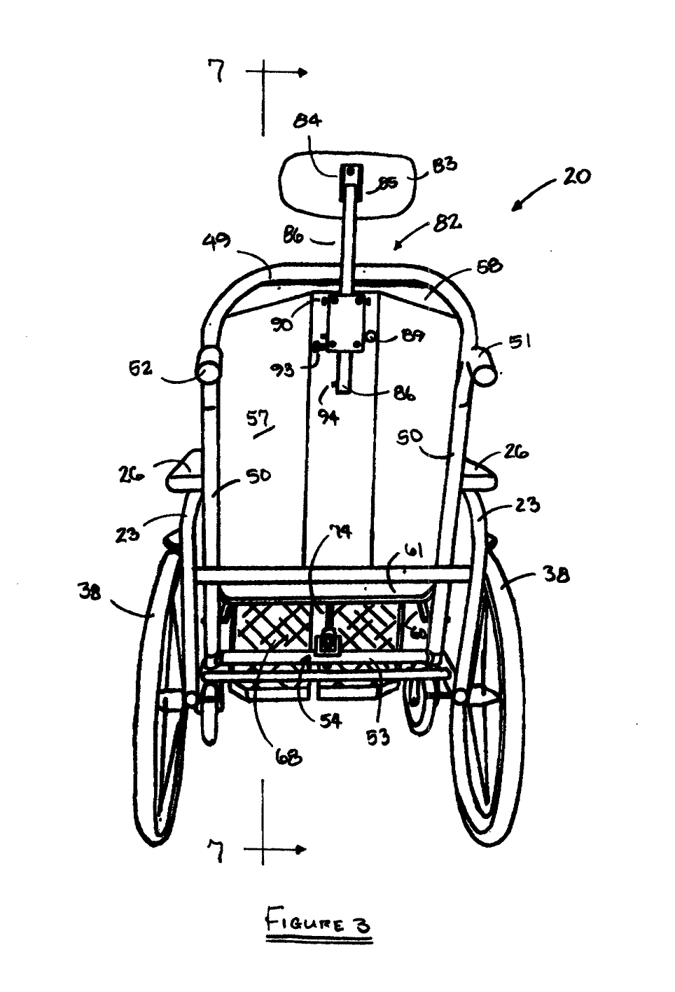

As particularly shown in FIGS. 1 through 4, the adjustable wheelchair 20 of the present invention incorporates many of those features commonly implemented in other wheelchair designs. For example, the adjustable wheelchair of 20 is provided with two main wheels 38 and two front casters 43. The main wheels 38, as commercially available from such manufacturers as Skyway Machine, Inc. of Redding, Calif., each have a hand rim 39 and at least one and preferably both of the main wheels 38 are provided with a wheel lock 41. Each main wheel 38 is dependently affixed through a hub 40 to a conventional axle fitting 28, comprising an inner axle plate 29 and an outer axle plate 30 joined with a steel tube 31, fixedly attached to the base frame assembly 21. In the preferred embodiment of the present invention, a wheel fender 42 is aesthetically provided about the upper portion of each main wheel 38 for improving the overall appearance of the adjustable wheelchair 20 while also protecting against inadvertent entanglement of clothing and the like in the main wheels 38. As in many wheel chair embodiments, each front caster 43, as also available from such manufacturers as Skyway Machine, Inc., is conventionally journalled to a jam nut 33 fixedly provided at the base of each front structural member 32 forming a portion of each side frame 22 of the base frame assembly 21.

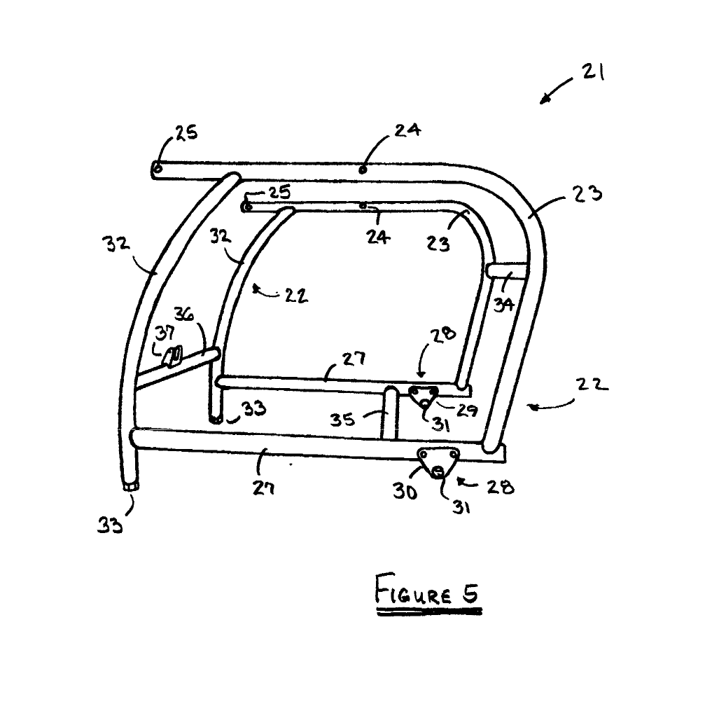

As particularly shown in FIG. 5, the base frame assembly 21 generally comprises left and right side frames 22, each having a unitary upper and rear structural member 23, a lower longitudinal structure member 27 and a front structural member 32. The side frames 22 are permanently adjoined by an upper transverse structural member 34, a lower transverse structural member 35 and a forward transverse structural member 36, which also serves as a point of attachment for a forward clevis 37. As will be better understood further herein, the forward clevis 37 is utilized to affix the articulation mechanism 71 to the base frame assembly 21 and thereby enable adjustment of the seat frame assembly 44 with respect to the base frame assembly 21. As also will be better understood further herein, each unitary upper and rear structural member 23 is provided with a pivot plate fitting 24 and a tie rod fitting 25 for pivotal attachment of the seat frame assembly 44 to the base frame assembly 21 in the manner contemplated by the present invention. Finally, a plurality of arm rests 26, as best shown in FIGS. 1 through 4, are conventionally provided atop each unitary upper and rear structural member 23 of the base frame assembly 21.

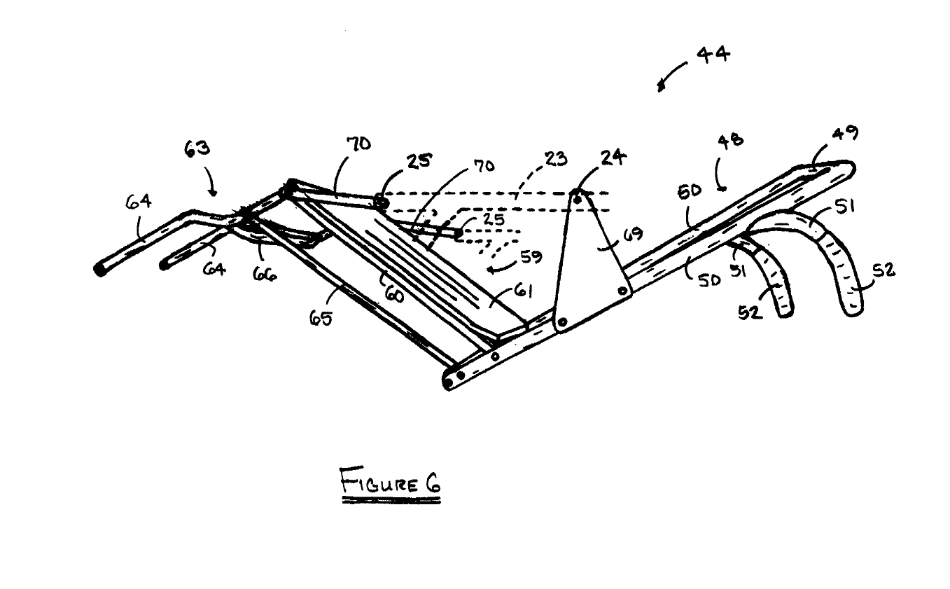

As particularly shown in FIG. 6, the articulating seat frame assembly 44 of the present invention generally comprises a seat back frame 48, a seat frame 59 and a leg frame 63. According to the preferred embodiment of the present invention, the seat back frame 48 is constructed of two generally longitudinal members 50 joined at their top portions by a transverse member 49. As is conventional with other wheelchair designs, the longitudinal members 50 present a convenient location for the provision of handles 51, which are preferably provided with hand grips 52 such as are commercially available from such manufacturers as EEZER Products, Inc. of Fresno, Calif. In the preferred embodiment of the present invention, the longitudinal members 50 are also joined at their lower portions by a cross tube 53, which provides a location for the conventional attachment of a rear clevis assembly 54. The rear clevis assembly 54, which generally comprises a clevis 55 having trunnion mounted therein a swivel nut 56, is utilized to affix the articulation mechanism 71 to the seat frame assembly 44 and thereby enable articulation of the seat frame assembly 44 with respect to the base frame assembly 21. Finally, a seat back 57, which is preferably shaped to comfortably cradle the torso region of a patient, is provided in the seat back frame 48 along with a conventional back cushion 58.

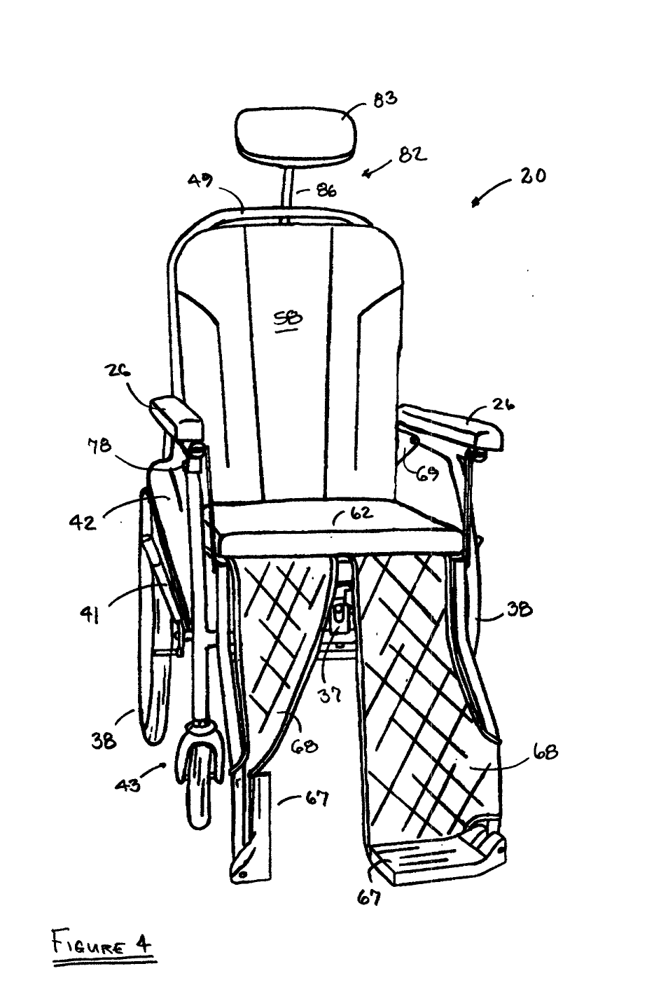

The seat frame 59 generally comprises two longitudinal seat supports 60, each extending between the lower potion of one longitudinal member 50 of the seat back frame 48 and one longitudinally extending member 64 of the leg frame 63. The longitudinal seat supports 60 combine to form a plurality of shelves for support of a conventional seat base 61, which may then support a conventional seat cushion 62. In addition to the longitudinally extending member 64, the leg frame 63 also comprises a plurality of folding foot rests 67 and a plurality of webbed leg rests 68. The webbed leg rests 68, which preferably comprise a conventional mesh material, are stretched between one each of the folding foot rests 67 and approximately half of a transverse member 66 provided between the upper portions of the longitudinally extending members 64. Applicant has found that the implementation of such webbed leg rests 68 enables comfortable and firm support of the patient's lower legs through a structure easily displaced when so desired by the patient, as particularly shown in FIG. 4.

In a critical aspect of the present invention, as particularly shown in FIGS. 6 through 8, a combination of push rods 65 and tie rods 70 are provided for controlling the relative articulation of the torso section 45 and leg section 47 with respect to the seat section 46 as the seat frame assembly 44 is adjusted between the seated position and supine position. As the seat frame assembly 44, which is pivotally secured to the base frame assembly 21 through a plurality of pivot plates 69 fixedly attached to the longitudinal members 50 of the seat back frame 48 and pivotally attached to the pivot plate fittings 24 provided in the unitary upper and rear structural members 23 of the base frame assembly 21, is adjusted between the seated and supine positions, the push rods 65 and tie rods 70 operate to constrain articulation of the seat frame assembly 44 such that contracture-related pain is greatly reduced or wholly avoided. The details of this coordinated and constrained motion will be better understood further herein.

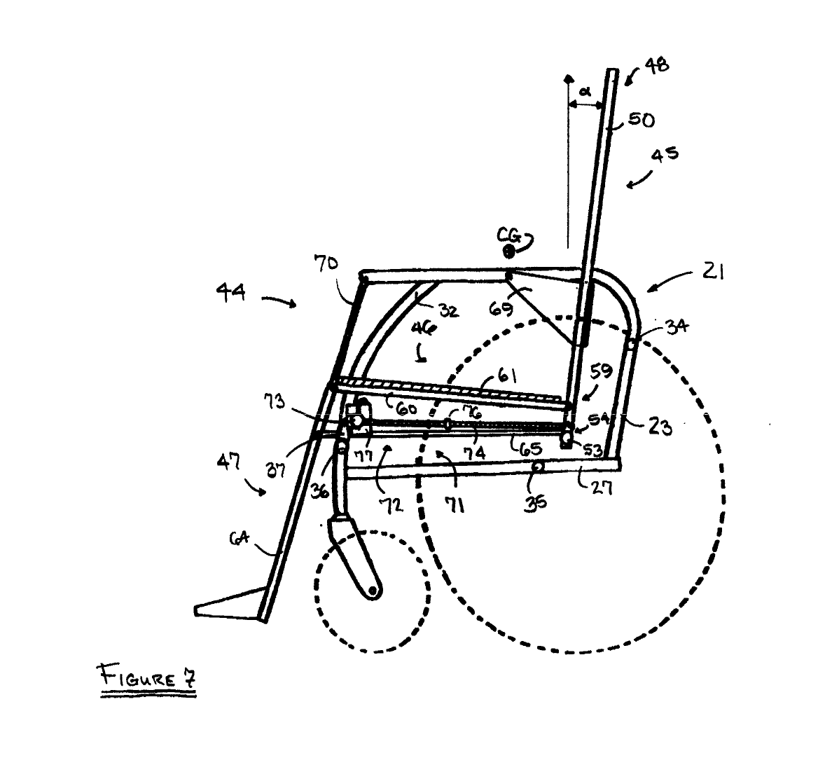

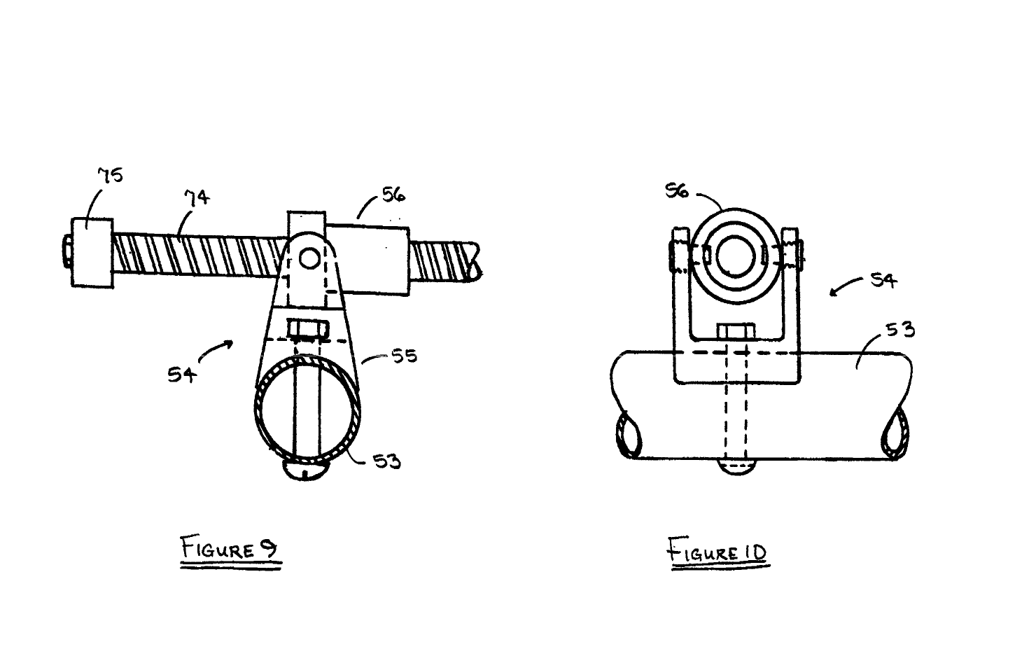

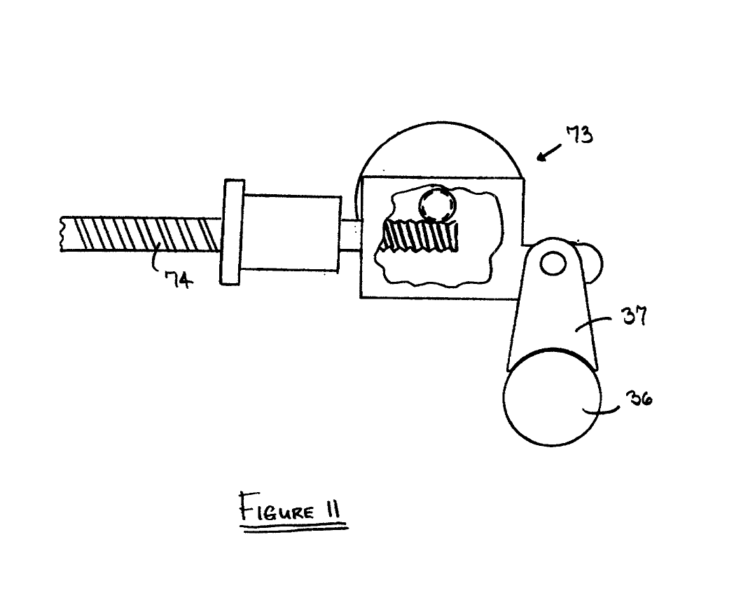

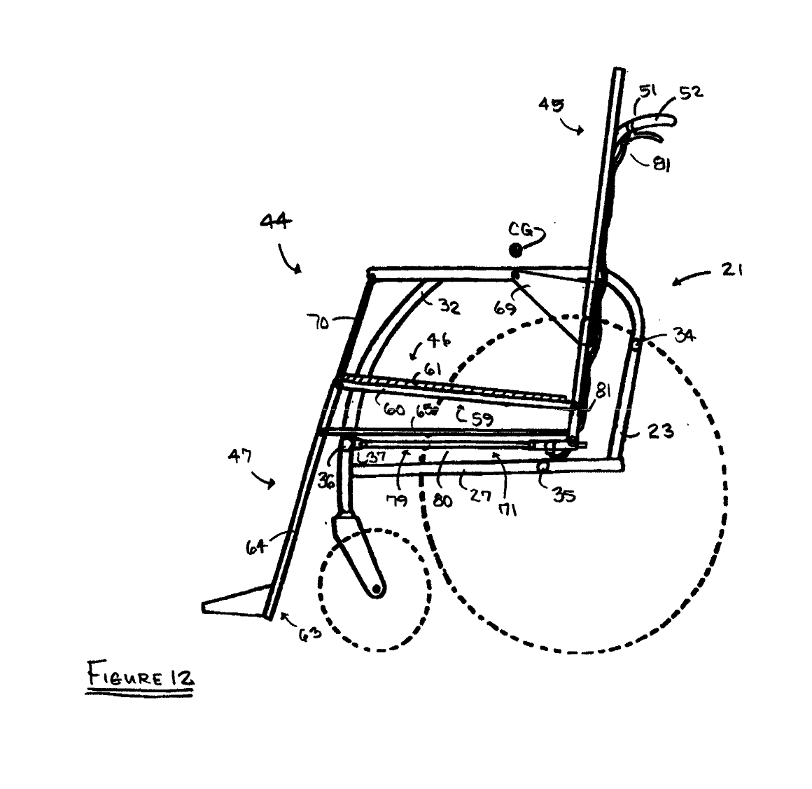

As particularly shown in FIGS. 7 through 12, an articulation mechanism 71 is provided for controlling adjustment of the seat frame assembly 44 with respect to the base frame assembly 21. In the preferred embodiment of the present invention, the articulation mechanism 71 generally comprises an electric actuator assembly 72 dependently interposed between the forward clevis 37 and the rear clevis assembly 54. The electric actuator assembly 72 generally comprises a ball joint actuator 73, with a screw 74 operably associated therewith, and an appropriate power source 77, such as a hospital grade battery or the like. Although those of ordinary skill in the art will recognize many substantially equivalent implementations, Applicant has found that the model 85616 ball joint actuator available from Motion Systems Corp. of Eatontown, N.J. is suitable for use with the present invention. As shown in FIGS. 7 through 11, the ball joint actuator 73 is pivotally secured with conventional mounting hardware to the forward clevis 37 while the screw 74 is adjustably received within the swivel nut 56 of the rear clevis assembly 54. In this manner the cross tube 53 of the seat back frame 48 may be drawn toward or pushed away from the forward transverse structural member 36 of the base frame assembly 21 as power is applied to the ball joint actuator 73 through an appropriate actuator switch 78 such as the double-pole, double-throw model J37 rocker actuator commercially available from the Electroswitch unit of Electro Switch Corp. of Weymouth, Mass.

As shown in FIGS. 7 through 9, the screw 74 terminates in a journal bearing 75 and is also provided with a supine position stop 76 at a point intermediate the ball joint actuator 73 and the rear clevis assembly 54. In this manner, the articulation mechanism 71 is adapted to constrain adjustment of the seat frame assembly 44 with respect to the base frame assembly 21 such that the angle α formed between the torso section 45 and a vertical reference, as shown in FIG. 7, is maintained within a range that is both safe and comfortable for the patient utilizing the adjustable wheelchair 20. Although the angle α may range as wide as from approximately 0°, corresponding to the seated position, to approximately 80°, corresponding to the supine position, Applicant has found that a slightly tighter range of adjustment is preferred in order to ensure sufficient adjustment of the seat frame assembly 44 while minimizing risk for inflicting contracture-related pain upon the patient. To this end, it is most preferred that the angle α be constrained to within a range of approximately 10° to approximately 60°.

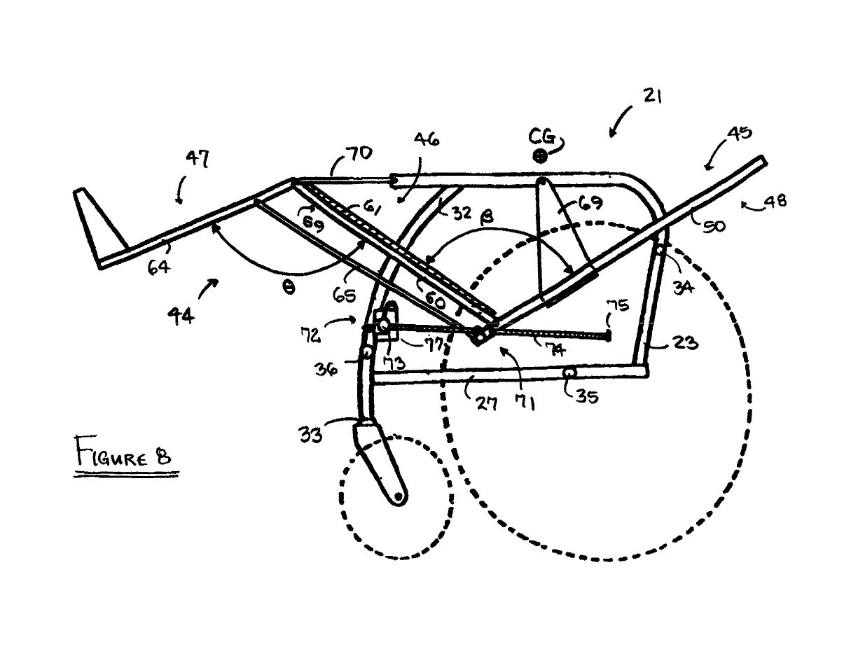

While the recline angle α of the seat frame assembly 44 is constrained by the journal bearing 75 and supine position stop 76, the seat back angle β and knee gatch angle θ, as depicted in FIG. 8, are constrained in relation to angle α by the push rods 65 and tie rods 70. In particular, the articulation of the torso section 45 with respect to the seat section 46 is constrained such that the angle β is approximately maintained during adjustment of the seat frame assembly 44 within a range defined by the relationship:

β=S₁+R₁(α−10°),

where S₁ is any angle between approximately 90° and approximately 120° and R₁ is a first tolerance value, preferably within the range of approximately 0.2 to approximately 0.8. Likewise, the articulation of the leg section 47 with respect to the seat section 46 is constrained such that the angle θ is approximately maintained during adjustment of the seat frame assembly 44 within a range defined by the relationship:

θ=S₂+R₂(α−10°),

where S₂ is any angle between approximately 90° and approximately 120° and R₂ is a second tolerance value, preferably also within the range of approximately 0.2 to approximately 0.8. Although Applicant has found, through confidential experimental testing, that the foregoing values produce suitable results for minimizing contracture-related discomfort, tighter tolerance values are nonetheless preferred in order to ensure the least likelihood for pain during adjustment of the wheelchair's seat frame assembly 44 with respect to the base frame assembly 21. Nominally, S₁ should be approximately 95° and S₂ should be approximately 105°. Likewise the nominal tolerance value for both R₁ and R₂ is approximately 0.5.

Although it is not completely understood why the previously described system of constraints and coordinated movements produces the result of the present invention, confidential experimentation has borne out the critical nature of the described ranges. Further, it should be noted that the method of affixation of the seat frame assembly 44 to the base frame assembly 21 also results in a nearly stationary patient center of gravity CG, even during adjustment of the wheelchair 20. This too is considered an important aspect of the present invention inasmuch as maintenance of a stationary center of gravity not only results in relief of contracture-related pain but also promotes balance atop the base frame assembly 21, thereby increasing patient safety. Further the described configuration results in elimination of sheer forces to the patient as the seat frame assembly 44 is adjusted between the seated and supine positions and also minimizes the force required of the articulation mechanism 71 in adjusting the wheelchair 20.

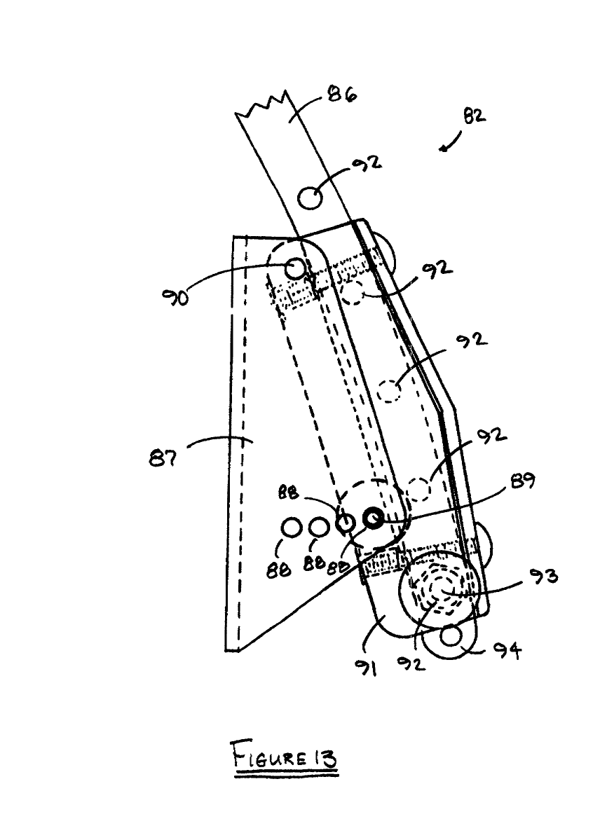

Although the preferred embodiment of the present invention comprises the electric actuator assembly 72 as previously described, those ordinary skill in the art will recognize that other substantially improvement implementations of the articulation mechanism 71 are possible. For example, as particularly shown in FIG. 12, a mechanical actuator assembly 79 may be implemented. In implementing such an alternative, one or more mechanical locks 80 may be provided in place of the electric actuator assembly 72. One such mechanical lock 80 is commercially available from P. L. Porter Controls, Inc., of Woodland Hills, Calif. as substantially described in U.S. Pat. No. 4,577,730 issued Mar. 25, 1996 to Porter. By this reference, the full disclosure of U.S. Pat. No. 4,577,730 is incorporated herein as though now set forth in its entirety. As will be apparent to those of ordinary skill in the art, the implementation of mechanical actuator assembly 79 also requires replacement of the power source 77 and actuator switch 78 with mechanical controls, such as cable controls 81. Suitable controls are available from the Wescon Products Co. subsidiary of Latshaw Enterprises, Inc. of Wichita, Kans.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, the preferred embodiment of the present invention comprises a headrest assembly 82 particularly adapted for comfortably supporting the patient's head in any position between the seated and the supine. As particularly shown in FIG. 13, the headrest assembly 82 generally comprises a headrest 83 dependently supported upon a curved support arm 86 attached to the wheelchair's seatback 57 through a pivot bracket 87 and slide block 91. According to the preferred embodiment of the present invention, the headrest 83 is pivotally attached to the curved support arm 86 at a swivel point 85 in a provided headrest bracket 84. In order to most comfortably support the patient's head, the provided pivot bracket 87 allows for the inward and outward adjustment of the headrest 83 according to the selection of an appropriate adjustment aperture 88 with detent pin 89 as the upper portion of the headrest assembly 82 pivots about the swivel point 90. Likewise, upward and downward adjustment of the headrest 83 is made possible through the selection of an appropriate adjustment aperture 92 with spring-loaded adjustment pin 93. A stop pin 94 is provided to prevent the inadvertent removal of the support arm 86 from the slide block 91. In any case, because the scope of the present invention is much broader than any particular embodiment, the foregoing detailed description should not be construed as a limitation of the scope of the present invention, which is limited only by the claims appended hereto.

What is claimed is:

1. An adjustable wheelchair for relieving the effects of contracture, said wheelchair comprising:
a base frame assembly;
a seat frame assembly pivotally supported by said base frame assembly, said seat frame assembly having a torso section, a seat section and a leg section and being adjustable between a seated position and a supine position; and
wherein:
adjustment of said seat frame assembly between said seated position and said supine position is measurable by an acute angle α between said torso section and a vertical reference;
said torso section is adapted to articulate with respect to said seat section, the articulation of said torso section being measurable by an acute angle β between said torso section and said seat section;
said leg section is adapted to articulate with respect to said seat section, the articulation of said leg section being measurable by an acute angle θ between said leg section and said seat section;
the articulation of said torso section and said leg section with respect to said seat section are constrained such that the angle β and the angle θ change concurrently with, and within predefined limits according to, the angle α as said seat frame assembly is adjusted between said seated position and said supine position.

2. The adjustable wheelchair as recited in claim 1, wherein the angle α is limited to a range of approximately 0°, corresponding to said seated position, to approximately 80°, corresponding to said supine position.

3. The adjustable wheelchair as recited in claim 2, wherein:
the articulation of said torso section with respect to said seat section is constrained such that the angle β is approximately maintained during adjustment of said seat frame assembly within a range defined by the relationship:
β=S₁+R₁(α−10°)
where S₁ is any angle between approximately 90° and approximately 120° and R₁ is a first tolerance value, said first tolerance value being within the range of approximately 0.2 to approximately 0.8; and
the articulation of said leg section with respect to said seat section is constrained such that the angle θ is approximately maintained during adjustment of said seat frame assembly within a range defined by the relationship:
θ=S₂+R₂(α−10°)
where S₂ is any angle between approximately 90° and approximately 120° and R₂ is a second tolerance value, said second tolerance value being within the range of approximately 0.2 to approximately 0.8.

4. The adjustable wheelchair as recited in claim 3, wherein the angle α is further limited to a range of approximately 10°, corresponding to said seated position, to approximately 60°, corresponding to said supine position.

5. The adjustable wheelchair as recited in claim 3, wherein:
said angle S₁ is any angle between approximately 90° and approximately 100° and said first tolerance value is within the range of approximately 0.4 to approximately 0.6; and
said angle S₂ is any angle between approximately 100° and approximately 110° and said second tolerance value is within the range of approximately 0.4 to approximately 0.6.

6. The adjustable wheelchair as recited in claim 5, wherein the angle α is further limited to a range of approximately 10°, corresponding to said seated position, to approximately 60°, corresponding to said supine position.

7. The adjustable wheelchair as recited in claim 3, wherein:
said angle S₁ is approximately 95° and said first tolerance value is approximately 0.5; and
said angle S₂ is approximately 105° and said second tolerance value is approximately 0.5.

8. The adjustable wheelchair as recited in claim 7, wherein the angle α is further limited to a range of approximately 10°, corresponding to said seated position, to approximately 60°, corresponding to said supine position.

9. The adjustable wheelchair as recited in claim 1, wherein a supported patient's center of gravity is maintained substantially stationary during adjustment of said seat frame assembly between said seated position and said supine position.

10. The adjustable wheelchair as recited in claim 9, where said center of gravity is at a position generally intermediate a rear pair of wheels and a forward pair of wheels.

11. The adjustable wheelchair as recited in claim 1, wherein the articulation of said torso section and said leg section with respect to said seat section are constrained through the provision of a push rod between said torso section and said leg section and a tie rod between said base frame assembly and said seat frame assembly.
